(19) United States
(12) Patent Application Publication
(10) Pub. No.: US 2025/0083235 A1
(43) Pub. Date: Mar. 13, 2025

(54) Depowdering For Additive Manufacturing

(71) Applicant: AZOTH INC., Ann Arbor, MI (US)

(72) Inventors: Mattia FORGIARINI, Gemona del Friuli (IT); Cody COCHRAN, Jackson, MI (US); Christopher Bryant Williams, Blacksburg, VA (US)

(73) Assignee: AZOTH INC., Ann Arbor, MI (US)

(21) Appl. No.: 18/631,366

(22) Filed: Apr. 10, 2024

Related U.S. Application Data
(60) Provisional application No. 63/537,254, filed on Sep. 8, 2023.

(51) Int. Cl. B22F 10/68; B22F 10/14; B28B 1/00; B28B 11/22; B33Y 40/20; B33Y 50/00

(52) U.S. Cl. CPC B22F 10/68; B28B 11/22; B33Y 40/20; B33Y 50/00; B22F 10/14; B28B 1/001

(57) ABSTRACT

A workpiece-depowdering method and apparatus are provided. In another aspect, a method includes: robotically gripping an additively manufactured workpiece within an enclosure; and automatically blowing gas onto the additively manufactured workpiece to remove extra powder from the additively manufactured workpiece. A further method includes: additively layering powder within an additive manufacturing station, moving the additively manufactured workpiece to a depowdering station; holding the additively manufactured workpiece adjacent to the at least one nozzle with an automatically controlled gripper within the depowdering station; and depowdering the additively manufactured workpiece in the depowdering station by the gas. Another aspect provides a machine including: a robot configured to grip a workpiece; and a nozzle configured to blow excess powder off of the workpiece.

### CROSS-REFERENCE TO RELATED APPLICATIONS

This application claims priority to U.S. provisional application Ser. No. 63/537,254, filed on Sep. 8, 2023, which is incorporated by reference herein.

### BACKGROUND AND SUMMARY

The present disclosure generally relates to additive manufacturing and more particularly to a depowdering machine and method for additive workpiece manufacturing.

Additive metal manufacturing has been rapidly developing. Examples of such machines and processes are disclosed in the following U.S. Patent Publication Nos.: 2019/0030810 entitled “Build Material Container” to Gasso, et al.; 2021/0237160 entitled “Methods and Devices for Three-Dimensional Printing” to Barbati, et al.; 2022/0032377 entitled “Systems and Methods for Powder Bed Density Measurement and Control for Additive Manufacturing” to Hudelson, et al.; 2022/355549 entitled “Removing Objects from a Volume of Build Material” to Gomez, et al.; and 2003/0133822 entitled “Method and Apparatus for Producing Free-Form Products” to Harryson. All of these patent publications are incorporated by reference herein.

Metal binder jetting is an additive manufacturing method consisting of selectively joining powdered material together, layer by layer, to make objects from digital three-dimensional model data. Metal binder jetting is a two-step process where the manufactured objects are printed and densified in separate steps. A printing step includes high-precision inkjet printing of binder on a metal powder bed or substrate. Metal powder is bonded together when the binder is jetted on the powder bed in a selective manner, corresponding to a desired cross-sectional shape of the objects being manufactured. In a cyclical manner, the powder bed is lowered and recoated with additional loose powder on top to form the next layer, to which the binder is printed. This is repeated layer-by-layer until an entire build box is filled with metal powder. Accordingly, the printed objects are in a “green state” wherein the consolidated powder forms are held together by binder, that have not yet been sintered for final strength. Details of metal binder jetting are disclosed in Mostafaei, A., et al., “Binder Jet 3D Printing—Process Parameters, Materials, Properties, Modeling, and Challenges,” Progress in Materials Science 119 (2021) 100707.

However, conventional additive metal manufacturing requires tedious and time consuming manual depowdering of excess remaining powder from the objects, after the powder layering machine and before the sintering furnace. A person typically employs a hand-held tube and directs blown air at an object held in the person's other hand, within a sealed transparent enclosure having glove access, for this traditional manual depowdering. Thereafter, the person manually places the depowdered object in a container for subsequent manual removal from the enclosure and placement into a sintering furnace.

Other theoretical attempts at depowdering are disclosed in the following U.S. Patent Publication Nos.: 2013/0244040 entitled “Three-Dimensional Shaping Method and Shaped Object Complex as Well as Three-Dimensional Shaping Apparatus” to Oshima; and 2021/0053121 entitled “Techniques for Depowdering Additively Fabricated Parts Through Vibratory Motion and Related Systems and Methods” to Go, et al. These patent publications are also incorporated by reference herein. The Go device teaches removal of excess powder from the additively layered object through vibration-inducing motors. The Oshima device discloses blowing off excess powder by wind pressure or via sound wave vibrations, however, it does not discuss the details including whether such is manual or automated.

In accordance with the present invention, a workpiece-depowdering method and apparatus are provided. In another aspect, a method includes: robotically gripping an additively manufactured workpiece within an enclosure; and automatically blowing gas onto the additively manufactured workpiece to remove extra powder from the additively manufactured workpiece. A further method includes: additively layering powder and jetting binder within an additive manufacturing station, moving the additively manufactured workpiece to a depowdering station; holding the additively manufactured workpiece adjacent to the at least one nozzle with an automatically controlled gripper within the depowdering station; and depowdering the additively manufactured workpiece in the depowdering station by the gas. Yet another aspect provides a method including removing powder from an additively manufactured workpiece while the additively manufactured workpiece is robotically gripped. In still another method of making additively manufactured workpieces, the method includes: additively layering powder to create additively manufactured workpieces; and robotically moving each of the additively manufactured workpieces in an individualized manner to oriented positions within a sintering tray. Another aspect of the method includes: removing excess powder; automatically sensing an excess powder condition of the additively manufactured workpiece; sending a signal from a sensor to a programmable controller in response to the sensing step; and the controller automatically determining if the excess powder condition is acceptable.

A further aspect employs programmable software including: instructions configured to move a robotic arm; instructions configured to cause a gripper coupled to the robotic arm to grip a workpiece; instructions configured to energize a compressor to blow a gas to a nozzle; and instructions configured to move the robotic arm while the gas is emitted from the nozzle at the workpiece. Another aspect provides a machine including: a robot configured to grip a workpiece; and a nozzle configured to blow excess powder off of the workpiece. Moreover, another machine includes: a nozzle located within an enclosure and being configured to blow excess powder off of an additively layered workpiece located within the enclosure; and a blower coupled to the enclosure and including a fan and a slotted outlet which is configured to create an air curtain.

The present depowdering method and machine are advantageous over traditional constructions. For example, the present method and machine achieve automated workpiece handling, depowdering and/or depowder condition sensing which all significantly decrease processing time, reduce expense, improve quality, reduce workpiece breakage and reduce manual operator tedium. For example, the present automated depowdering achieves at least 95% excess powder removal within approximately 40 seconds or less per workpiece, depending on the size and shape of the workpiece being employed. This can be contrasted to the conventional manual procedure taking more than one minute, with inconsistent depowdering results. Moreover, the present process and apparatus reduce the risks associated with a manual operator inhaling the very fine excess powder, and eliminate the need for an operator to manually hold a workpiece and hold an air hose in uncomfortable position with the operator's hands inserted in sealed gloves in a depowdering cabinet. Additional features and advantages of the present method and machine can be ascertained from the following description and associated claims as well as from the appended figures.

### BRIEF DESCRIPTION OF THE DRAWINGS

FIG. 1 is a perspective view showing the preferred embodiment of the present depowdering machine;

FIG. 2 is a top elevational view showing the present depowdering machine;

FIG. 3 is a perspective view showing an exemplary workpiece employed with the present depowdering machine;

FIG. 4 is a perspective view showing a robot of the present depowdering machine, including an enlargement of gripper fingers thereof;

FIG. 5 is a side elevational view showing a stationary nozzle of the present depowdering machine;

FIG. 6 is a perspective view showing the stationary nozzle of the present depowdering machine;

FIG. 7 is a front elevational view showing the stationary nozzle of the present depowdering machine;

FIG. 8 is a cross-sectional view, taken along line 8-8 of FIG. 7, showing the stationary nozzle of the present depowdering machine;

FIG. 9 is a perspective view showing the robotic gripper and an alternate embodiment stationary nozzle of the present depowdering machine;

FIGS. 10-14 are a series of perspective views showing the robotic gripper and movable nozzle relative to the workpiece and the stationary nozzle of the present depowdering machine;

FIG. 15 is a diagrammatic view showing an exemplary robotic gripper movement pattern adjacent to the stationary nozzle of the present depowdering machine;

FIG. 16 is a perspective view showing a sintering collection tray employed in the present depowdering machine;

FIG. 17 is a block electrical diagram of the present depowdering machine;

FIGS. 18 and 19 are process flow diagrams for the present depowdering machine;

FIGS. 20 and 21 are software and controller block diagrams for the present depowdering machine;

FIG. 22 is a perspective view showing an optional optical sensor of the present depowdering machine;

FIG. 23 is process flow diagram for the optional optical sensor of the present depowdering machine; and

FIG. 24 is a perspective view showing an optional air curtain of the present depowdering machine.

### DETAILED DESCRIPTION

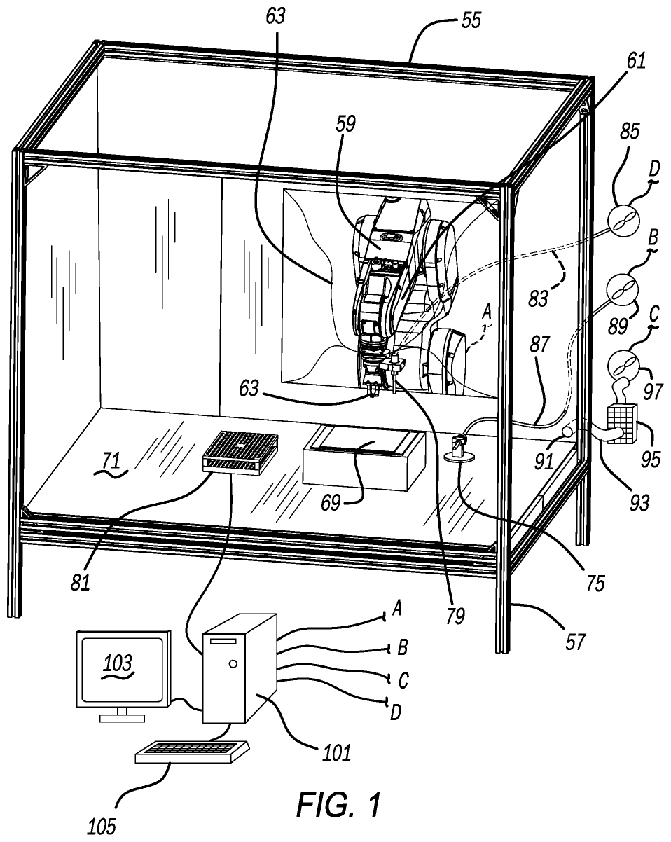

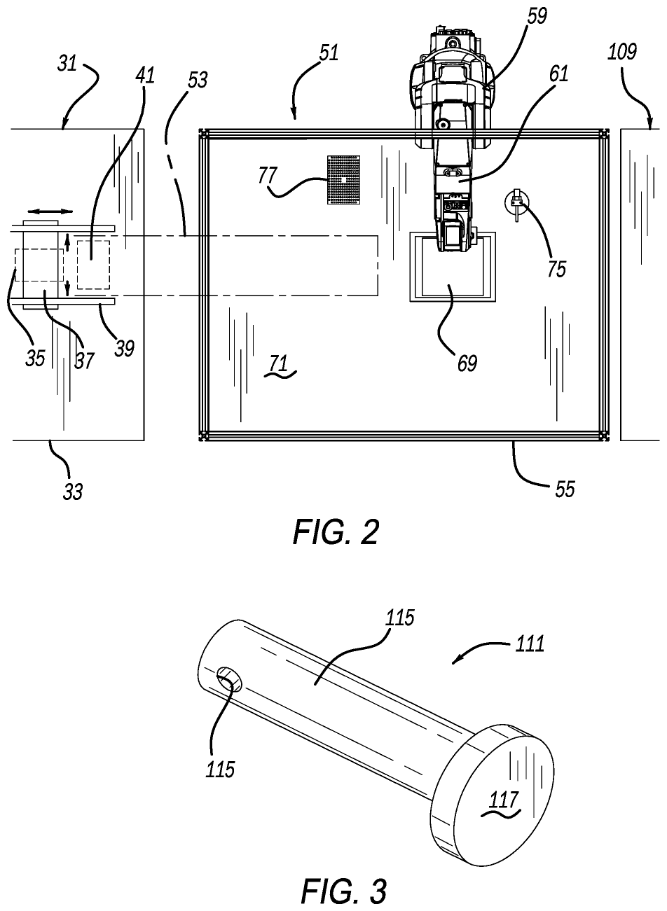

A preferred embodiment of an additive manufacturing facility can be observed in FIGS. 1 and 2. A three-dimensional printing (“3DP”) machine or station 31 includes an enclosure 33, within which is a binder jet printing head 35 which laterally traverses back and forth along a laterally elongated carriage 37. Carriage 37, in turn, is longitudinally moveable back and forth between longitudinally elongated and stationary rails 39, between which is a vertically movable bed 41. 3DP head 35 deposits powdered metal and/or ceramic particles, upon which is jetted a binding agent, onto bed 41 along a programmed workpiece pattern. The bed downwardly moves after each layer has been deposited so that the layers are in a stacked arrangement to create one or more powder-encased workpieces on bed 41. The workpieces are in an initial, green-cured state when the 3DP process is completed.

The 3DP workpieces are then moved on a bed or platform surface to a depowdering machine or station 51 after the workpieces have been completely formed in the 3DP machine 31. This movement between stations can be manually performed or the bed 41 and/or a platform on the bed, may be automatically transported by a conveyor belt 53 or the like. Depowdering station 51 includes a sealed enclosure or cabinet 55 having legs 57 upstanding on a factory floor.

An articulated robot 59 has a base stationarily mounted to the factory floor, and multiple arms 61 with multi-axial joints therebetween, powered by automatically controlled actuators, such as electric motors, solenoids, hydraulic pistons, or the like. A flexible hood 63 has an opening through which a distal end of arm 61 and/or a gripper 63 extend. An end effector 90 movably couples the gripper to the robotic arm. Hood 63 internally seals to the end effector and peripherally to a rear opening in enclosure 55, but allows movement of the robotic arm, end effector and gripper within enclosure 55.

Depowdering station 51 further includes a platform 69, somewhat centrally located on a floor 71 of enclosure 55. A stationary outlet nozzle assembly 75 is also mounted to floor 71 on a longitudinal side of platform 69 opposite that of a sintering tray or container 77. A movable outlet nozzle 79 is mounted on gripper 63 for movement therewith. Optionally, a scale sensor 81 is located between tray 77 and floor 71.

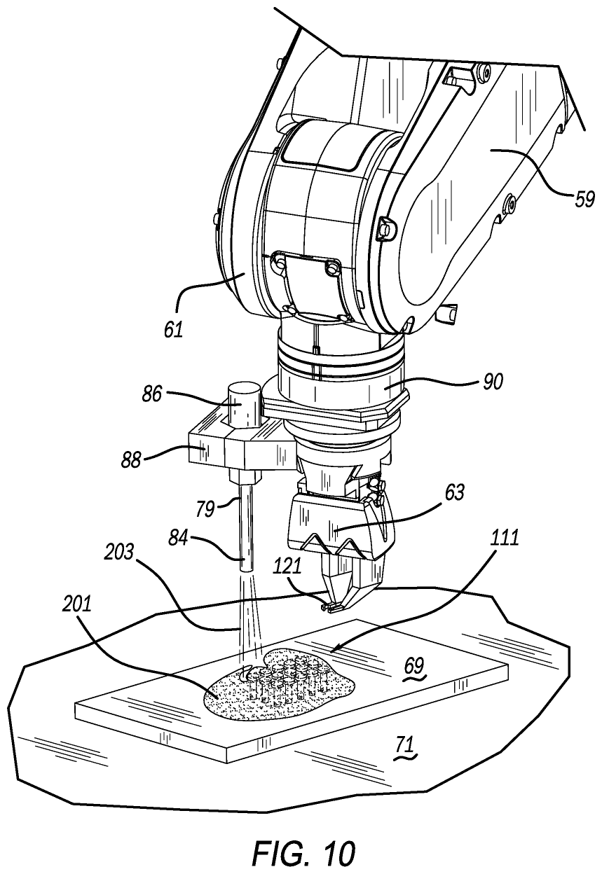

Movable outlet nozzle 79 is coupled to a flexible hose 83, which in turn, is coupled to a compressor fan or blower 85 for blowing a gas, such as air, nitrogen or argon, out of movable outlet nozzle 79. As can best be observed in FIG. 10, movable outlet nozzle 79 includes an elongated and hollow nozzle or outlet tube 84 extending from a mounting body 86. A clamp 88 couples the mounting body to a side of end effector 90 of robotic arm 61.

Moreover, stationary outlet nozzle 75 is coupled to a flexible hose 87, as can be seen in FIG. 1. Hose 87 is, in turn, coupled to a compressor fan or blower 89 for blowing a gas, such as air, nitrogen or argon, out of stationary outlet nozzle 75. One or more exhaust ports or outlets 91 are located adjacent a rear and bottom corner of enclosure 55, and is connected to a tube 93, filter 95 and vacuum pump 97. Filter serves to separate and recycle the excess powder for optional subsequent reuse during the 3DP step.

FIGS. 1 and 17 also show a programmable controller 101 including a microprocessor, RAM and ROM non-transient memory, and electrical circuits therein. An output display 103 and input keyboard 105 are also connected to controller 101. Electrical circuits connect controller 101 to robotic actuators 104, scale sensor 81, compressors/air supplies 85/89 and associated solenoid-operated valves 106, exhaust vacuum pump 97, and optionally to 3DP station 31 (see FIG. 2) and conveyor 53. Software instructions programmed and stored into the memory and operated by microprocessor, for controlling the depowdering station and optionally, the 3DP station will be discussed in greater detail hereinafter. When the depowdering process has been completed, the depowdered workpieces and associated tray 77 are either manually or automatically moved into a sintering machine or station, such as a sintering furnace 109.

Controller 101 is optionally connected to an HVAC and dehumidifying system coupled to enclosure 55. Thus, controller 101 optionally causes an atmosphere within the enclosure to be overpressurized or underpressurized as compared to ambient air pressure outside the enclosure. Furthermore, controller 101 optionally senses and controls a temperature within the enclosure to be 10-95° C. during depowdering, while also sensing and controlling humidity to a pre-determined range within the enclosure during depowdering.

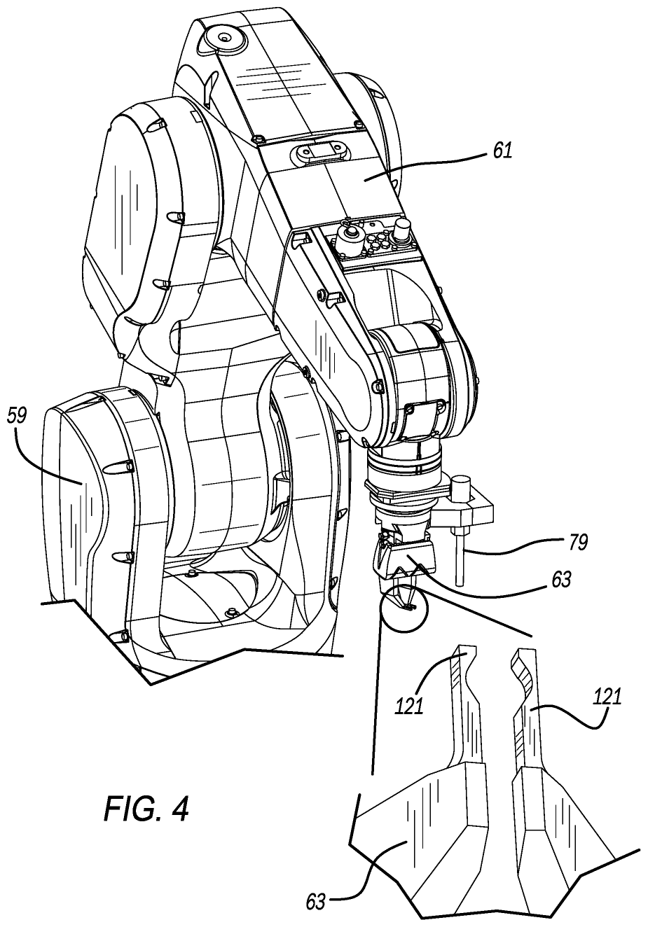

Referring to FIGS. 3 and 4, in one exemplary embodiment ideally suitable for use in the present depowdering station, a workpiece 111 includes an elongated cylindrical shaft 113 within which is an internal through hole 115 or concavity adjacent one end, and an enlarged head 117 at the opposite end. Each workpiece 111 is temporarily gripped within movable and elongated fingers 121 of robotic gripper 63. For the present exemplary workpiece 111, each finger 121 has an arcuate receptacle approximately matching and for receiving the exterior shape of shaft 113 therein. Optionally, a force sensor may be attached to one or more of the gripping fingers, which will then send a gripping signal to the controller for energization/deenergization of an actuator controlling movement of the gripper.

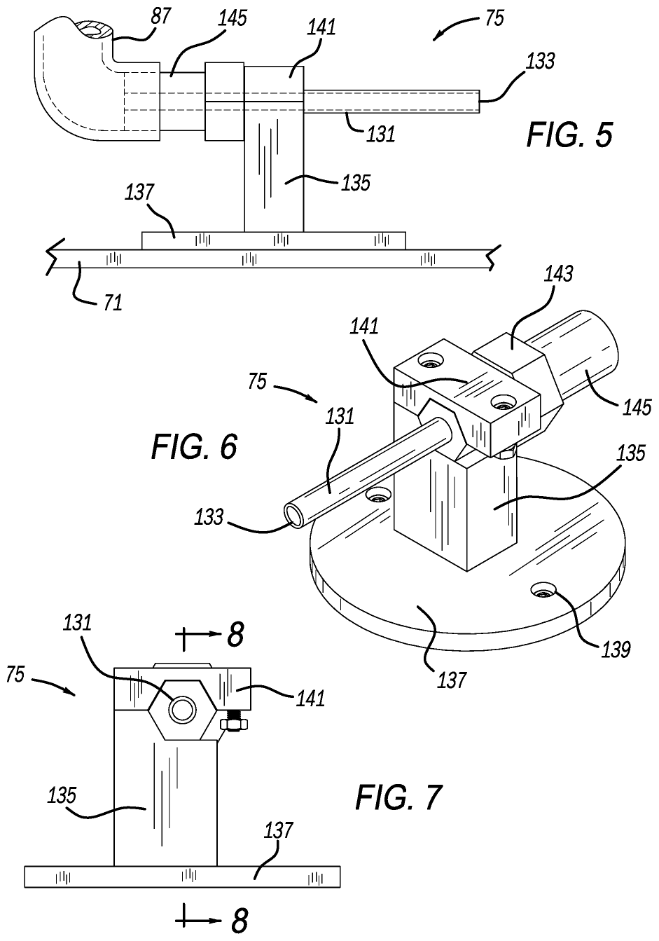

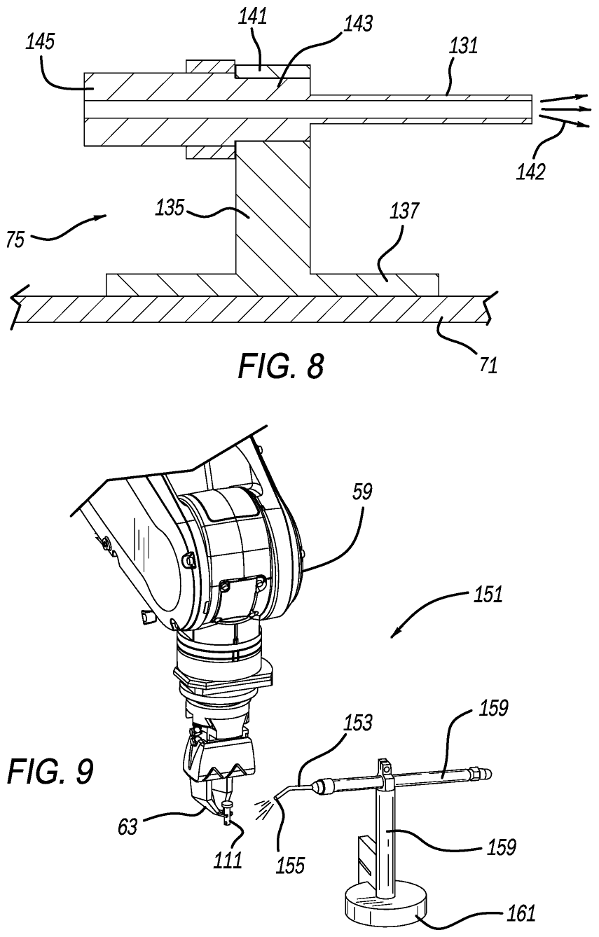

FIGS. 5-8 show stationary outlet nozzle 75, which includes an elongated and hollow nozzle or tube 131 with an outlet opening 133 in a distal end thereof. An elongated bracket 135 upstands from a laterally enlarged base 137, attached to floor 71 of the enclosure by screw fasteners 139, bolts, rivets, welds or adhesive. A clamp 141 is bolted or otherwise removably attached to bracket 135 for securing a middle mounting section 143 secured to tube 131. A fitting 145, located on a backend of stationary outlet nozzle 75 opposite outlet opening 133, is coupled to hose 87.

Gas 142, preferably air, is blown through and out of stationary outlet nozzle 75 at outlet opening 133. In one design, pressure of the air is 0.5-80 psi at an outlet diameter of 0.05-5.0 mm, although these values may vary depending on the workpiece shape and powder characteristics.

In an alternate configuration, stationary nozzle assembly 75, or a plurality of stationary nozzle assemblies, is positioned within enclosure 55 to create a vortex turbulence of the gas to cause depowdering of the additively manufactured workpiece within the enclosure. In another variation, bracket 135 of stationary nozzle assembly may contain an electromagnetically or fluid powered swivel joint at adjacent base 137 to allow rotation of nozzle tube 131 about a stationary rotational axis. As an alternate configuration, the programmable controller automatically varies a flow characteristic of the gas, between multiple positive gas flow conditions, during depowdering of the additively manufactured workpiece within the enclosure; this includes different flow pressures, flow speeds, flow directions, or the like.

A differently constructed stationary nozzle assembly 151 is illustrated in FIG. 9. A nozzle tube 153 has an outlet 155 which is offset angled in a downwardly pointing direction from an elongated axis of a middle section 157. The middle section is clamped upon a cylindrical and vertically elongated bracket 159, and a laterally enlarged base 161 is stationarily mounted to an inside surface of the enclosure floor.

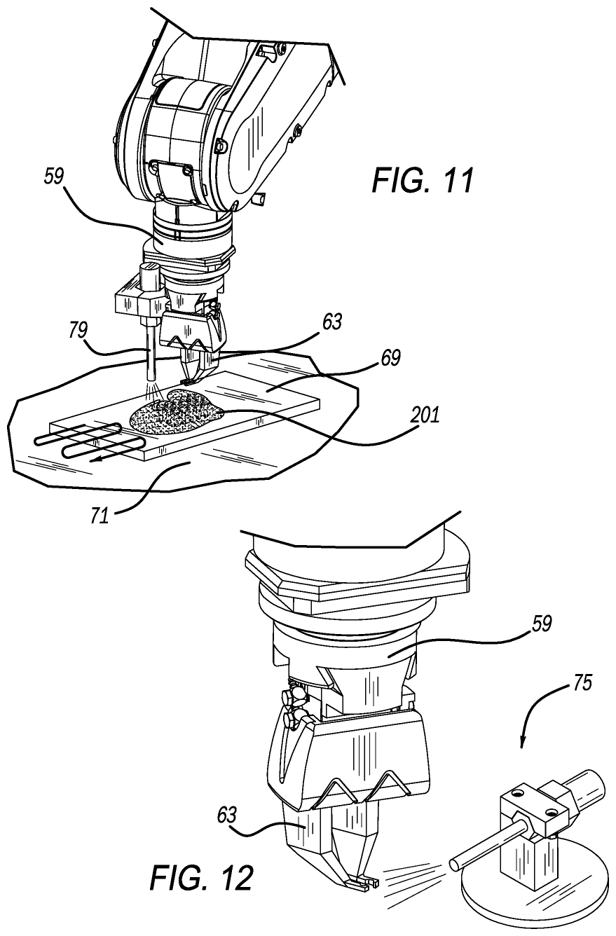

The functionality of the present depowdering machine and method will now be discussed. FIGS. 10 and 11 illustrate robot 59 orienting gripper 63 in a generally lowered position spaced above a pile of workpieces 111 covered by excess powder 201. Before gripper fingers 121 grab one of the workpieces, air 203 is blown downwardly from movable nozzle assembly 79 onto the powder covered workpieces 111 sitting on platform 69. The controller and its associated software energize the blower associated with movable nozzle assembly 79 while also causing robot 59 to move in a generally serpentine or zig-zag, laterally back and forth, and longitudinally traversing initial depowdering pattern spanning across the powder covered workpieces 111. These actions initially and automatically blow off at least some of the excess powder 201 from the workpieces 111 en mass. This initially blown off powder will be sucked out of the exhaust outlet.

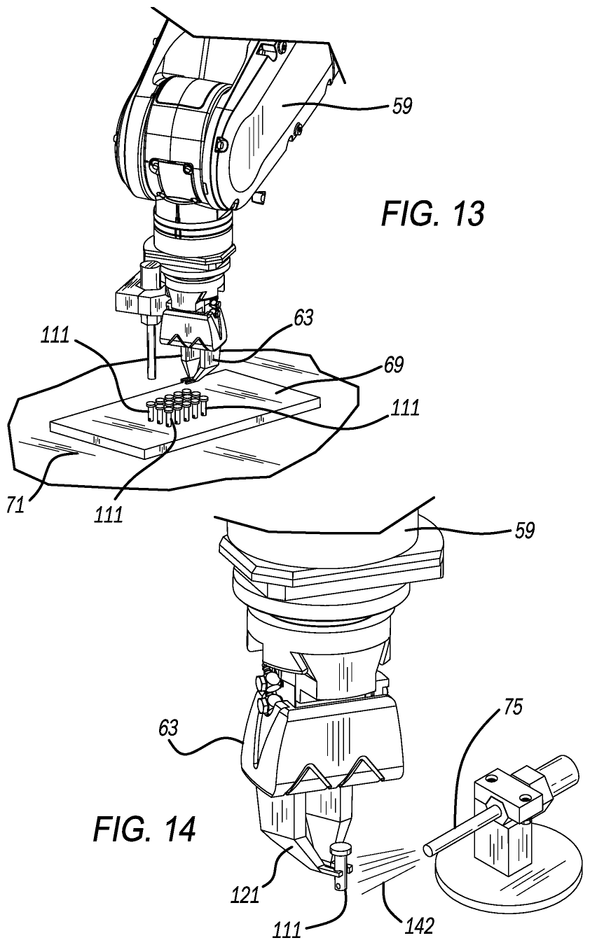

Next, FIG. 12 shows controller and its software optionally causing robot 59 to move gripper 63 adjacent to stationary nozzle assembly 75. The controller and its software energize the associate blower to push air out of the stationary nozzle assembly to blow off any excess powder remaining on the fingers of gripper 63. The controller and its software then move robot and its gripper back to a position aligned above workpieces 111, as can be observed in FIG. 13.

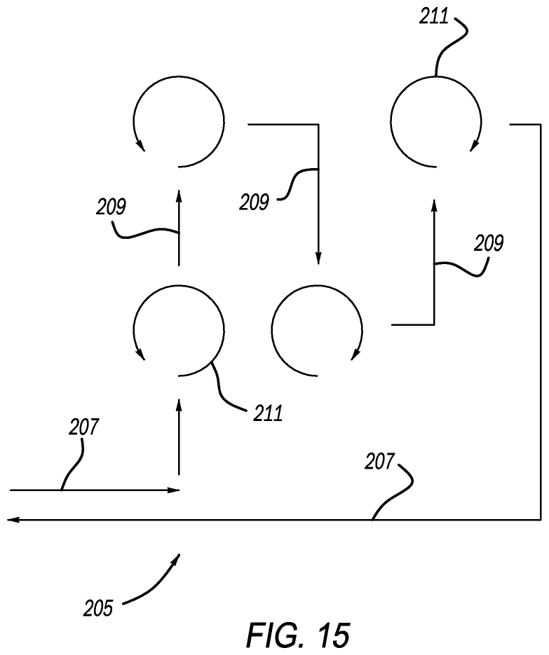

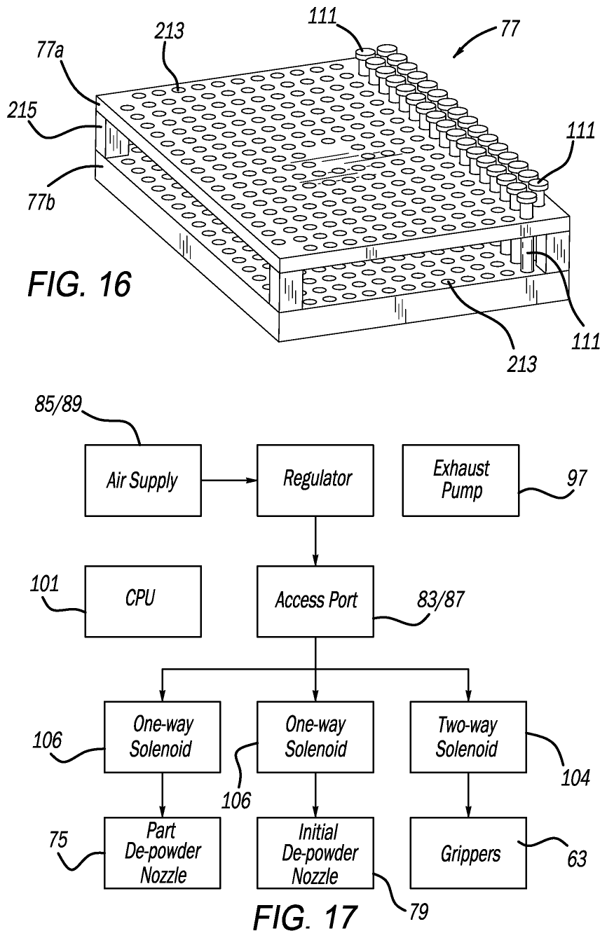

With reference to FIGS. 14 and 15, the controller and its software subsequently energize the actuators of robot 59 to move gripper 63 adjacent to stationary nozzle assembly 75. In this step, the gripper has gripped one of the workpieces 111 between its fingers 121, keeping in mind, that some excess powder is still on workpiece 111. The robot removes the gripped workpiece from the build box platform in an individualized manner; in other words, one at a time. Gripper 63 and gripped workpiece 111 are linearly and/or rotationally moved, and/or inverted, to expose different surfaces of the workpiece 111 to the air 142 directly flowing from the stationary nozzle assembly 75. An exemplary gripper and workpiece depowdering pattern 205 are illustrated in FIG. 15, which includes various linear horizontal movements 207 and linear vertical movements 209 along a generally vertical plane, plus multiple clockwise and counterclockwise rotations 211 along generally horizontal planes. This exemplary pattern is ideally suited for blowing air underneath the head of the workpiece and also inside the through-bore within the workpiece. However, many other zig-zag or alternate movement patterns may be employed depending on the specific workpiece shapes. This secondary air blowing on the workpieces is intended to remove the remaining excess powder off of each workpiece, in an individualized manner.

Thereafter, the robot aligns and places the depowdered workpiece within a single or an aligned set of receptacle holes 213 within sintering tray 77. Tray 77 may optionally include multiple stacked sub-trays 77a and 77b spaced apart by columns 215 or the like, depending on the workpiece configuration. The gripper fingers then release and disengage the workpiece and subsequently repeat the individualized gripping and stationary nozzle depowdering cycle. Optionally, the programmable software further may include additional instructions automatically creating a depowdering movement pattern for the robot by interpreting or deciphering 3D printing build data.

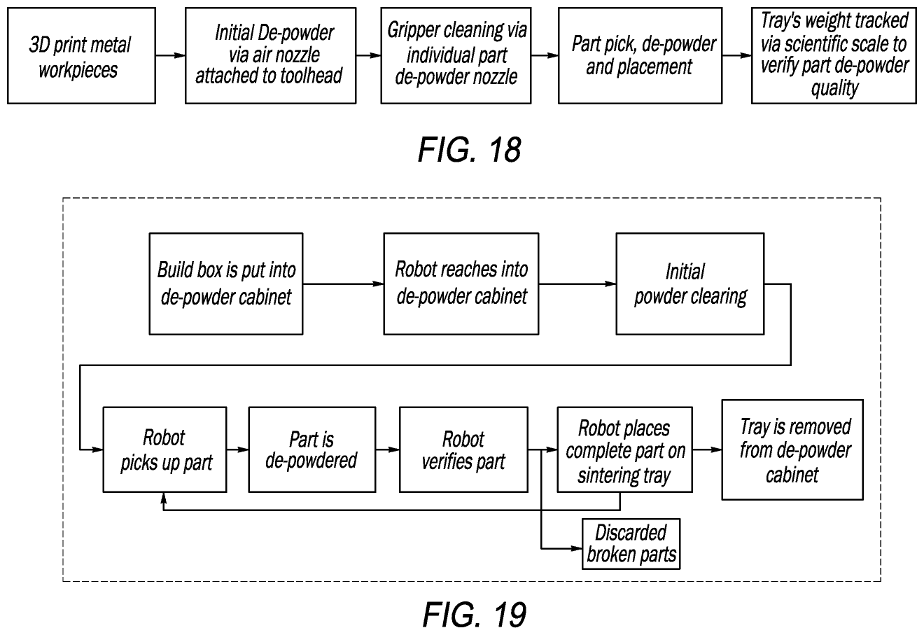

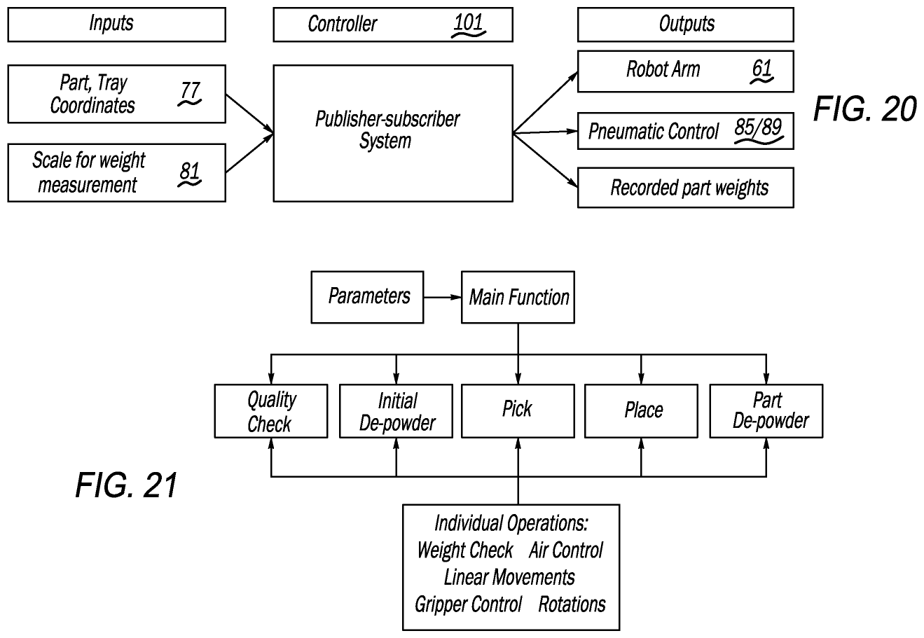

Optionally, automatic depowdering quality control can be achieved through use of a sensor coupled to controller 101. In one configuration shown in FIGS. 1, 18, 20 and 21, scale 81 is located within the enclosure below tray 77. It senses the weight increase due to each depowdered workpiece 111 placed in the tray. The mass/weight signal is sent from the scale to the controller and the software instructions therein automatically determine if the sensed weight value exceeds a pre-determined desirable threshold value. If it does, the controller may optionally cause the robotic gripper to remove the undesirable workpiece from the tray and put it in a segregated rework pile or container, and/or send a warning indication to operator for subsequent remedial manual depowdering action. This weight sensing and threshold determination can optionally be used to automatically determine if there is a forming irregularity in the 3DP of the workpiece, unrelated to the depowdering, which may be due to too much or too little material therein; this can automatically trigger robotic movement of the workpiece and/or a warning indication.

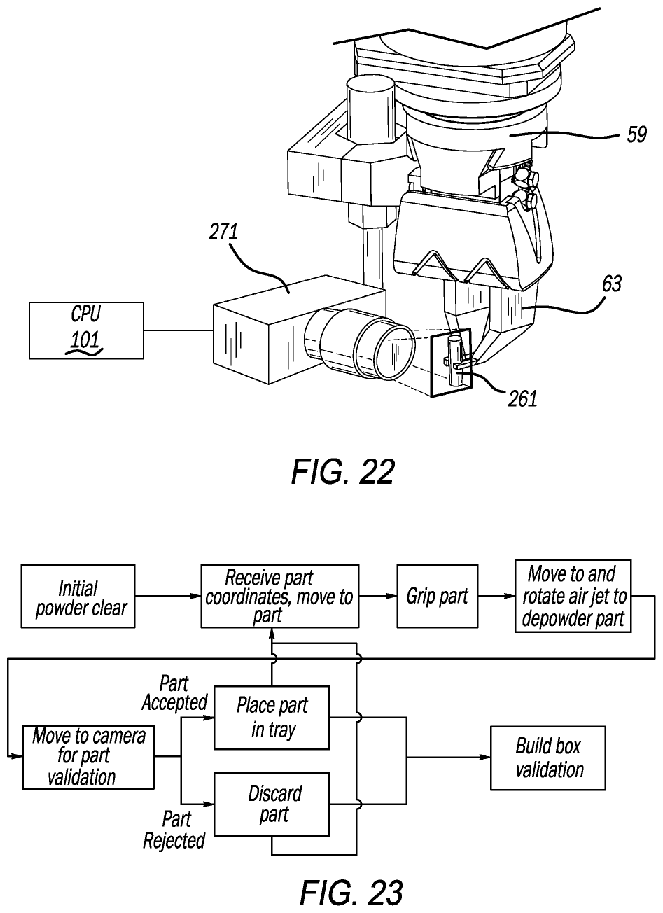

Another depowdering sensing option is an optical comparison, as is illustrated in FIGS. 19, 22 and 23. In this configuration, a CCD camera 271 senses an image of a workpiece 261 as it is held by robotic gripper 63 after depowdering. Camera sends an image signal to controller 101, which compares the sensed image to a pre-determined image of what a properly depowdered version of the workpiece should look like in digital form. If the controller automatically determines that the sensed image differs by an undesirable amount, then it can automatically cause the robot to place the workpiece in a rework pile and/or send a warning output signal to the operator for subsequent remedial action. This optical sensing and threshold determination can optionally be used to automatically determine if there is a forming irregularity in the 3DP of the workpiece, before or after depowdering, and unrelated to the depowdering; this can automatically trigger robotic movement of the workpiece and/or a warning indication.

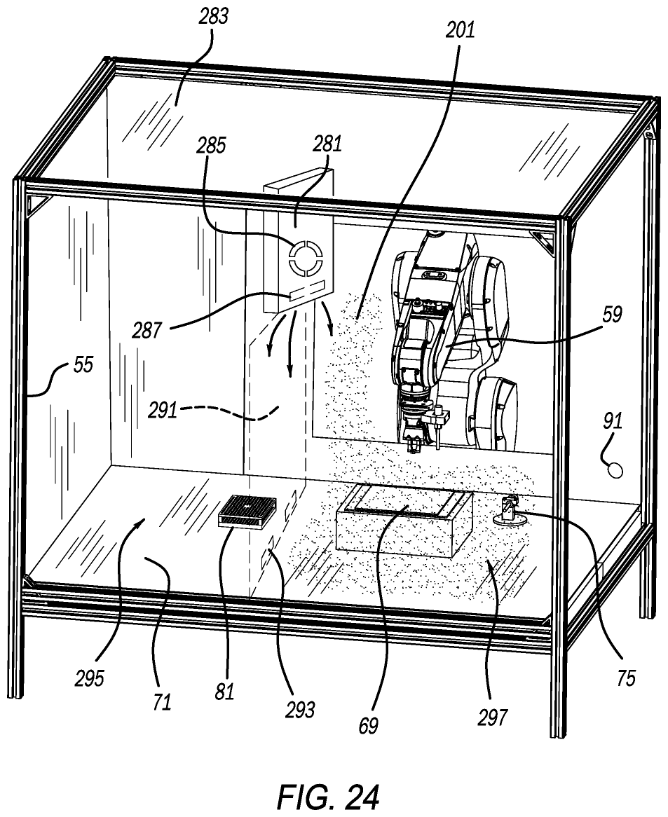

Referring now to an optional construction of FIG. 24, a curtain blower fan 281 is mounted to an interior surface to enclosure 55, such as downwardly hanging from a center of a roof 283 thereof. Curtain blower fan 281 includes an air inlet 285 and a slotted outlet 287 on a bottom edge thereof. An exterior air or gas supply hose may optionally be connected to the inlet. Air or an inert gas downwardly flows out of outlet 287 to create an air curtain 291 projecting along a generally vertical plane. One or more optionally exhaust slots 293 and associated hoses and filters may be located on floor 71 to deter turbulence caused by air curtain 291. Air curtain serves to separate a clean staging side 295 within enclosure 55 from a dirty depowdering side 297 within enclosure. The sintering tray is located within the clean side, and floating excess powder is located within the dirty side. The gripper of robot 59 can freely move between the dirty and clean sides. Optionally, the clean side may have a greater internal gas pressure therein as compared to the dirty side.

While various embodiments have been disclosed herein, it should be appreciated that other variations may be employed. For example, it is envisioned that the disclosed articulated robot may be replaced by a gantry robot or any other automated workpiece gripping mechanism, although certain benefits may not be fully achieved. Furthermore, alternate additive manufacturing processes and machines may be used, and using different materials, however, certain advantages of the present method and apparatus may not be realized. A sintering or other heating process and machine may or may not be employed, although this optional arrangement may not be as beneficial. Moreover, the individualized gripping and depowdering of each workpiece may be optionally replaced by robotically and/or automatically moving and blowing on a plurality of workpieces simultaneously, however, this may require more complex grippers and/or gas nozzles and patterns. Differently shaped and sized workpieces may alternately be employed.

Any and/or all of the features of any of the embodiments disclosed herein may be mixed and matched, and/or substituted for any of the other embodiment structures and functions herein. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method of making an additively manufactured workpiece, the method comprising:
(a) placing the additively manufactured workpiece inside an enclosure;
(b) robotically gripping the additively manufactured workpiece within the enclosure; and
(b) automatically blowing gas onto the additively manufactured workpiece to remove extra powder from the additively manufactured workpiece, within the enclosure.

2. The method of claim 1, further comprising robotically gripping the additively manufactured workpiece while the gas is blowing on the additively manufactured workpiece.

3. The method of claims 1, further comprising robotically moving the additively manufactured workpiece adjacent to a blower outlet, which is stationarily mounted inside the enclosure, while the air is blowing on the additively manufactured workpiece.

4. The method of any of claim 1, further comprising robotically moving the additively manufactured workpiece in at least a linear direction and a rotational direction adjacent to a blower outlet, which is mounted inside the enclosure, while the air is blowing on the additively manufactured workpiece.

5. The method of claim 1, further comprising gripping and robotically moving the additively manufactured workpiece in an individualized manner from a group of powder-covered workpieces from an initial position to a depowdering position and then to an individually oriented position within a sintering tray.

6. The method of claim 1, further comprising automatically causing the gas to flow from a movable blower outlet, mounted to a robot adjacent a workpiece-gripper, and robotically moving the movable blower outlet to remove at least some excess powder from a group of the additively manufactured workpieces before the additively manufactured workpiece is robotically gripped within the enclosure.

7. The method of claim 1, further comprising a programmable controller automatically causing:
a robotic gripper to grip the additively manufactured workpiece;
the robotic gripper to move the additively manufactured workpiece to an enclosure-mounted blower outlet;
energize an air compressor to flow air from the enclosure-mounted blower outlet to depowder the additively manufactured workpiece;
the robotic gripper to move the depowdered additively manufactured workpiece to a tray and place the additively manufactured workpiece in a desired orientation within the tray; and
determine if the additively manufactured workpiece is free of powder as sensed against a target depowdered value.

8. The method of claim 1, further comprising an optical sensor automatically detecting a depowdered image condition of the additively manufactured workpiece within the enclosure and sending a signal to a programmable controller which also controls a depowdering blower.

9. The method of claim 1, further comprising scale automatically detecting a depowdered weight condition of the additively manufactured workpiece within the enclosure and sending a signal to a programmable controller which also controls a depowdering blower.

10. The method of claim 1, further comprising:
flowing the gas from a compressor to the blower outlet within the enclosure, the gas including at least one of: nitrogen, argon or air;
an atmosphere within the enclosure being overpressurized or underpressurized as compared to ambient air pressure outside the enclosure;
removing the excess powder blown off of the additively manufactured workpiece from the enclosure through an exhaust outlet located in the enclosure and a conduit transporting the excess powder from the exhaust outlet to a filter;
controlling a temperature within the enclosure to be 10-95° C. during depowdering;
controlling a humidity within the enclosure during depowdering; and
the powder including at least one of metal or ceramic particles.

11. The method of claim 1, further comprising:
additively layering the powder in a programmed workpiece pattern on a moving bed within an additive metal binder jetting manufacturing machine, before the robotic gripping and depowdering steps; and
sintering the additively manufactured workpiece in an furnace, after the robotic gripping and depowdering steps.

12. The method of claim 1, further comprising creating a vortex turbulence of the gas to cause depowdering of the additively manufactured workpiece within the enclosure via multiple blower outlets mounted to an inside surface of the enclosure.

13. The method of claim 1, further comprising a programmable controller automatically varying a flow characteristic of the gas, between multiple positive gas flow conditions, during depowdering of the additively manufactured workpiece within the enclosure.

14. A method of making an additively manufactured workpiece, the method comprising:
(a) additively layering powder in a programmed workpiece pattern on a bed within an additive manufacturing station, the powder comprising at least one of: metallic particles or ceramic particles;
(b) moving the additively manufactured workpiece to a depowdering station after the layering;
(c) holding the additively manufactured workpiece adjacent to the at least one nozzle with an automatically controlled gripper within the depowdering station;
(d) flowing gas from at least one nozzle which is stationarily mounted in the depowdering station, the flowing gas being directed at the additively manufactured workpiece; and
(e) depowdering the additively manufactured workpiece in the depowdering station by the gas.

15. The method of claim 14, further comprising:
robotically moving the additively manufactured workpiece in at least a linear direction and a rotational direction adjacent to the at least one nozzle, which is mounted inside a sealed cabinet, while the gas is blowing on the additively manufactured workpiece; and
blowing the gas into an internal hole in the additively manufactured workpiece and removing excess powder from the hole, while the robot grips the additively manufactured workpiece in the depowdering station.

16. The method of claim 14, further comprising:
gripping and robotically moving the additively manufactured workpiece in an individualized manner from a group of powder-covered workpieces from an initial position to a depowdering position, within the depowdering station, and to an individually oriented position within a sintering tray; and
subsequently sintering the depowdered additively manufactured workpiece.

17. The method of claim 14, further comprising a programmable controller automatically and sequentially causing:
a robotic gripper to grip the additively manufactured workpiece;
the robotic gripper to move the additively manufactured workpiece to the at least one nozzle;
energize fan to flow the gas to depowder the additively manufactured workpiece; and
the robotic gripper to move the depowdered additively manufactured workpiece to a tray and place the additively manufactured workpiece in a desired orientation within the tray.

18. The method of claim 14, further comprising a sensor automatically detecting a depowdered condition of the additively manufactured workpiece and sending an associated signal to a programmable controller which automatically compares the detected condition to a target value.

19. The method of claim 14, further comprising:
moving workpiece-gripping fingers of an articulated robot inside of a sealed cabinet within which is the depowdering station;
the flowing the gas from a compressor to the at least one nozzle within the cabinet;
causing an atmosphere within the cabinet to be overpressurized or underpressurized as compared to ambient air pressure outside the cabinet;
removing the excess powder blown off of the additively manufactured workpiece from the cabinet through an exhaust outlet and a conduit transporting the excess powder from the exhaust outlet to a filter;
controlling a temperature within the cabinet to be maintained at 10-95° C. during the depowdering;
controlling a humidity within the cabinet during the depowdering; and
causing pressure of the gas to be 0.5-80 psi at an outlet diameter of 0.05-5.0 mm for the at least one nozzle.

20. A method of making an additively manufactured workpiece, the method comprising:
(a) robotically gripping the additively manufactured workpiece;
(b) robotically moving the additively manufactured workpiece while the additively manufactured workpiece is gripped; and
(c) removing powder from the additively manufactured workpiece while the additively manufactured workpiece is robotically gripped.

21. The method of claim 20, further comprising energizing a compressor connected to a nozzle directed at the additively manufactured workpiece in order to blow off powder from the additively manufactured workpiece.

22. The method of 21, wherein the robotically moving further comprises automatically rotating the additively manufactured workpiece adjacent to the nozzle, which is stationarily mounted inside a sealed enclosure.

23. The method of claim 20, further comprising blowing a gas from an outlet mounted on the robot to remove at least some of the powder from the additively manufactured workpiece before the additively manufactured workpiece is gripped by the robot.

24. The method of claim 20, wherein the moving further comprising moving the additively manufactured workpiece in an individualized manner from a group of powder-covered additively manufactured workpieces from an initial position to a depowdering position and then to an individually oriented position within a sintering tray.

25. The method of claim 20, further comprising a programmable controller automatically causing:
movable and elongated gripper fingers at an end of an articulated robot to grip the additively manufactured workpiece between the fingers within a enclosure;
the robot to move the additively manufactured workpiece to an enclosure-mounted air nozzle;
energize an air compressor to flow air from the enclosure-mounted air nozzle to depowder the additively manufactured workpiece while the robot moves the additively manufactured workpiece in a predetermined pattern adjacent to the enclosure-mounted air nozzle;
the robot to move the depowdered workpiece to a tray; and
determine if the depowdered workpiece is free of powder as sensed against a target depowdered value.

26. A method of making an additively manufactured workpiece, the method comprising:
(a) moving the additively manufactured workpiece within an enclosure while the additively manufactured workpiece has excess metal or ceramic powder thereon;
(b) energizing a gas compressor to flow gas from an enclosure-mounted outlet; and
(c) removing the excess powder from the additively manufactured workpiece during steps (a) and (b).

27. The method of claim 26, wherein the moving step further comprises:
robotically moving the additively manufactured workpiece in at least a linear direction and a rotational direction adjacent to the enclosure-mounted outlet, while the gas is blowing on the additively manufactured workpiece; and
blowing the gas into an internal hole in the additively manufactured workpiece and removing the excess powder from the hole, while the robot grips the additively manufactured workpiece.

28. The method of claim 26, wherein:
the moving step further comprises robotically moving the additively manufactured workpiece in an individualized manner from a group of powder-covered additively manufactured workpieces from an initial position to a depowdering position, within the enclosure, and to an individually oriented position within a sintering tray; and
subsequently sintering the depowdered workpiece.

29. The method of claim 26, further comprising a programmable controller automatically and sequentially causing:
a robotic gripper to grip the additively manufactured workpiece in the enclosure; and
the robotic gripper to move the depowdered workpiece to a tray and place the depowdered workpiece in a desired orientation within the tray.

30. The method of claim 26, further comprising a sensor automatically detecting a depowdered condition of the additively manufactured workpiece and sending an associated signal to a programmable controller which automatically compares the detected condition to a target value.

31. The method of claim 26, further comprising:
flowing the gas from the compressor to the outlet within the enclosure, the gas including at least one of: nitrogen, argon or air;
causing an atmosphere within the enclosure to be overpressurized or underpressurized, as compared to ambient air pressure outside the enclosure;
removing the excess powder blown off of the additively manufactured workpiece from the enclosure via an exhaust outlet and a conduit transporting the excess powder from the exhaust outlet to a filter;
controlling a temperature within the enclosure to be at 10-95° C. during depowdering; and
controlling a humidity within the enclosure during depowdering.

32. The method of claim 26, further comprising:
additively layering the powder in a programmed workpiece pattern on a bed within an additive manufacturing machine, before the moving step; and
sintering the additively manufactured workpiece in a furnace, after the removing steps.

33. The method of claim 26, further comprising creating a vortex turbulence of the gas to cause the powder removal step with multiples of the outlet mounted to an inside surface of the enclosure.

34. The method of claim 26, further comprising a programmable controller automatically varying a flow characteristic of the gas, between multiple positive gas flow conditions, during the powder removal step within the enclosure.

35. A method of making an additively manufactured workpiece, the method comprising:
(a) moving an additively manufactured workpiece within an enclosure while the additively manufactured workpiece has excess metal or ceramic powder thereon;
(b) removing the excess powder from the additively manufactured workpiece;
(c) automatically sensing an excess powder condition of the additively manufactured workpiece;
(d) sending a signal from a sensor to a programmable controller in response to the sensing step; and
(e) the controller automatically determining if the excess powder condition is acceptable.

36. The method of claim 35, wherein the moving step further comprises robotically moving the additively manufactured workpiece in at least a linear direction and a rotational direction adjacent to an enclosure-mounted gas nozzle, while blowing gas on the additively manufactured workpiece.

37. The method of claim 35, wherein:
the moving step further comprises robotically moving the additively manufactured workpiece in an individualized manner from a group of powder-covered additively manufactured workpieces from an initial position to a depowdering position, within the enclosure, and to an individually oriented position within a sintering tray; and
subsequently sintering the depowdered workpiece.

38. The method of claim 35, wherein the sensing further comprises using an optical sensor to automatically detect a depowdered image of the additively manufactured workpiece within the enclosure.

39. The method of claim 35, wherein the sensing further comprises using a scale to automatically detect a depowdered weight of the additively manufactured workpiece within the enclosure.

40. The method of claim 35, wherein the controller creates a visual or audible warning alert to an operator if the powder condition is determined to be unacceptable.

41. The method of claim 35, wherein the controller causes a robot to move the workpiece into an gas flow configured to remove the excess powder, if the powder condition is determined to be unacceptable.

42. The method of claim 35, wherein the controller changes a gas flow characteristic to remove the excess powder, if the powder condition is determined to be unacceptable.

43. The method of claim 35, wherein the controller causes a robot to move the workpiece to a holding location for manual removal of the excess powder, if the powder condition is determined to be unacceptable.

44. Programmable software, stored in non-transient memory, the software comprising:
(a) first instructions configured to move a robotic arm to a position aligned with a workpiece;
(b) second instructions configured to cause a gripper coupled to the robotic arm to grip the workpiece;
(c) third instructions configured to energize a compressor to blow a gas to a nozzle; and
(d) fourth instructions configured to move the robotic arm while the gas is emitted from the nozzle at the workpiece.

45. The programmable software of claim 44, wherein at least one of the instructions further comprises depowdering the workpiece, which is an additively manufactured metallic or ceramic workpiece, while the robot moves the gripped additively manufactured workpiece in a predetermined pattern adjacent to a stationary nozzle.

46. The programmable software of claim 44, wherein at least one of the instructions further comprises depowdering the workpiece, which is an additively manufactured metallic or ceramic workpiece, before the gripper grips the additively manufactured workpiece, by moving the nozzle with the robotic arm.

47. The programmable software of claim 44, further comprising additional instructions configured to cause the robot to move the depowdered workpiece to a sintering tray.

48. The programmable software of claim 44, further comprising additional instructions configured to determine if the depowdered workpiece is sufficiently free of excess powder as detected by a sensor.

49. The programmable software of claim 44, further comprising additional instructions automatically creating a depowdering movement pattern for the robot by interpreting or deciphering 3D printing build data.
